(19) United States
(12) Patent Application Publication
(10) Pub. No.: US 2021/0350720 A1
(43) Pub. Date: Nov. 11, 2021

(54) SYSTEM AND METHOD FOR SHOWING, TESTING AND CERTIFYING USERS IN-APP ON CLOUD APPLICATION WORKFLOWS

(71) Applicants: Kalpit Jain, SAN JOSE, CA (US); Neil Reddy Chintala, MILIPITAS, CA (US); Zhi Feng Huang, SAN JOSE, CA (US); Kaushal Mehta, FREMONT, CA (US); Alok Nandan, SANTA CLARA, CA (US)

(72) Inventors: Kalpit Jain, SAN JOSE, CA (US); Neil Reddy Chintala, MILIPITAS, CA (US); Zhi Feng Huang, SAN JOSE, CA (US); Kaushal Mehta, FREMONT, CA (US); Alok Nandan, SANTA CLARA, CA (US)

(21) Appl. No.: 16/412,389

(22) Filed: May 14, 2019

Related U.S. Application Data
(60) Provisional application No. 62/670,859, filed on May 14, 2018.

(51) Int. Cl. G09B 19/00; G06K 9/62; G09B 5/02; G06Q 10/10

(52) U.S. Cl. CPC G09B 19/0053; G06K 9/6256; G06N 20/00; G06Q 10/103; G09B 5/02

(57) ABSTRACT

In one aspect, a computerized method useful for showing, testing and certifying users in-application on cloud application workflows includes the step of triggering a test. The test tests and certifies a user on a specified software task with a specified software application. The method includes the step of tracking a set of user test data from the test. The method includes the step of using the set of user test data that is tracked to improve in application training workflows.

### CROSS-REFERENCE TO RELATED APPLICATIONS

This application claims priority to U.S. provisional patent application No. 62670859 filed on 14-MAY-2019. This application is hereby incorporated by reference in its entirety.

### BACKGROUND

### 1. FIELD

This application relates generally to online education, and more particularly to a system, method and article of manufacture of showing, testing and certifying users in-app on cloud application workflows.

### 2. RELATED ART

Companies and other enterprise utilize various applications to complete business-related tasks. These can be new applications that users need to be trained on. Additionally, previously/currently used applications can be updated. Updates can include new or different functionalities and workflows. Manual training can be time consuming and costly. Additionally, it is difficult to track user progress during manual trainings. Accordingly, improvements to automatically training, testing and tracking users through in-application workflows are desired.

### BRIEF SUMMARY OF THE INVENTION

In one aspect, a computerized method useful for showing, testing and certifying users in-application on cloud application workflows includes the step of triggering a test. The test tests and certifies a user on a specified software task with a specified software application. The method includes the step of tracking a set of user test data from the test. The method includes the step of using the set of user test data that is tracked to improve in application training workflows.

### BRIEF DESCRIPTION OF THE DRAWINGS

FIG. 1 illustrates an example online education system for software workflow application showing, testing and certifying, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 provides an example process for showing, testing and certifying users in-app on cloud application workflows, according to some embodiments.

FIGS. 5-11 illustrate a series of example screen shots that can be used to implement various embodiments.

The Figures described above are a representative set, and are not an exhaustive with respect to embodying the invention.

### Description

Disclosed are a system, method, and article of method and system of showing, testing and certifying users in-app on cloud application workflows. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Learning content can be content that is transformed into “learning” content based on policy on a per-organization basis.

Subject-matter expert can be a person who is an expert in a particular area or topic.

Exemplary Systems

It is noted that the corporate operations are often driven by a software workflow. The software workflow can include showing, testing and certifying users. This can have a positive impact on corporate employee productivity.

In one example, a bank can use tellers to perform wire transfers. a trained teller can perform a wire transfer in five minutes while an untrained teller may perform same transaction in one hour. This is a large difference in efficiency and can be the result of the effectiveness of an application workflow. The application workflows can be improved by testing and certifying users on said software workflows.

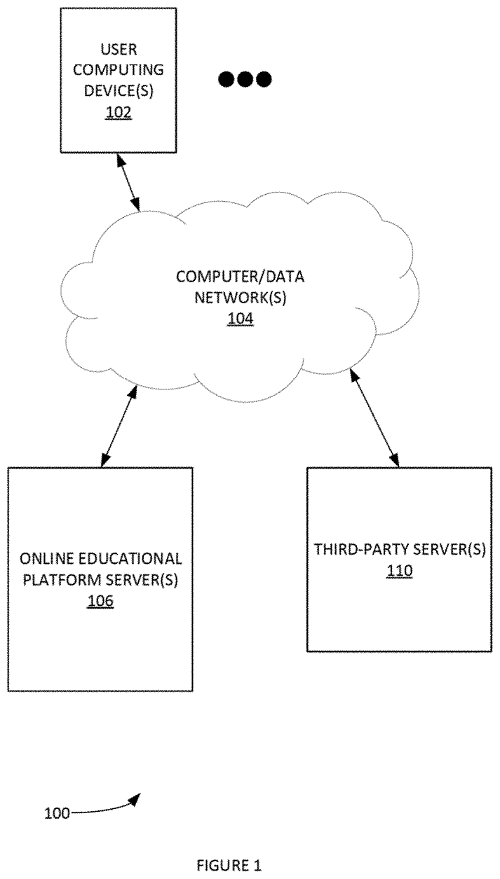

FIG. 1 illustrates an example online education system 100 for software workflow application showing, testing and certifying, according to some embodiments. System 100 can provide an online means of training and certifying third-party enterprise employees on specified software workflows.

Networks 104 can include the Internet, text messaging networks (e.g. short messaging service (SMS) networks, multimedia messaging service (MMS) networks, proprietary messaging networks, instant messaging service networks, email systems, etc. Networks 104 can be used to communicate messages and/or other information (e.g. videos, tests, articles, other educational materials, etc.) from the various entities of system 100.

System 100 can include an online education platform server(s) 106. User-computing devices 102 can be any computing device used by a user to access/consume educational content provided by system 100 (e.g. via online education platform 106). Example user-computing devices can include, inter alia: personal computers, mobile devices, augmented reality devices, virtual reality devices, tablet computers, etc. User-computing devices 102 can access education content via a website, local application and the like. User-computing devices 102 can enable a user to upload educational content to online education platform 106. User-computing devices 102 can enable a user to upload test results to online education platform 106. User-computing devices 102 can enable a user to comment and/or otherwise interact with (e.g. ‘like’, share, recommend, etc.) the educational content provided by online education platform 106. The educational content can include specified training courses that show, train and certify users on specified software workflows. The software workflows can be specified to an employees work-related tasks.

Online education platform 106 can manage and provide educational content to user-computing devices 102. For example, online education platform 106 can disseminate online courses, educational videos, educational articles, online exams, software application walkthroughs, etc. Online education platform 106 can provide interfaces for obtaining user information. Online education platform 106 can interact with and/or obtain information from third-party server(s) 110. Online education platform 106 can increase a user's productivity with software applications by showing, testing and certifying users on critical application workflows. In the present example, this can be implement with a set of ShowMe, TestMe and GuideMe modules. These modules can be enabled inside the application in question itself.

Online education platform 106 can include various other functionalities and systems, including, inter a/ia: email servers, text messaging servers, instant messaging servers, video-sharing servers, mapping and geolocation servers, network security services, language translation functionalities, database management systems, application programming interfaces, etc. Online education platform 106 can include various machine learning functionalities that can analyze user behavior, educational content, user profiles, etc. The analysis can be used to match users with educational content and/or otherwise optimize the user experience.

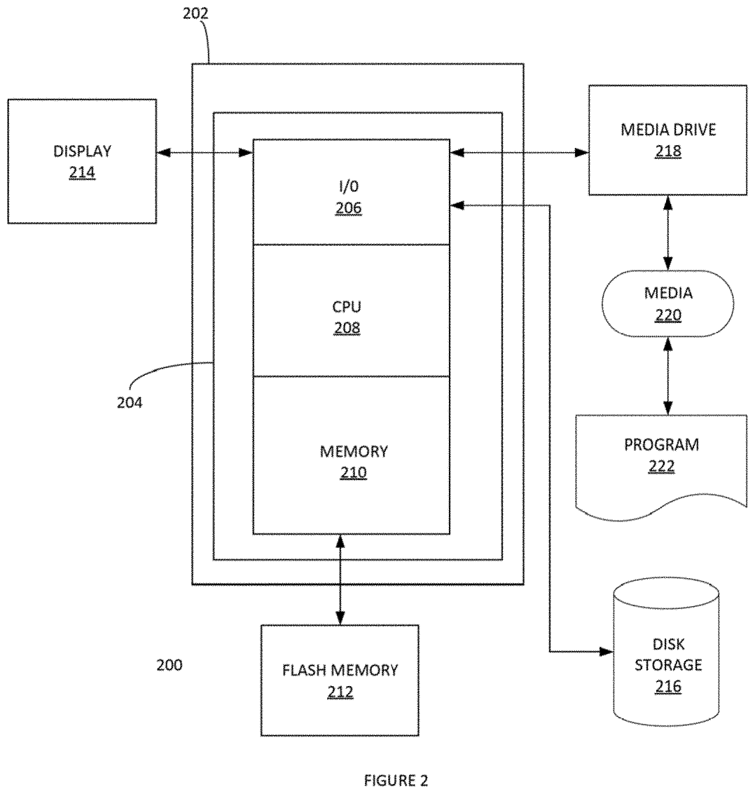

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

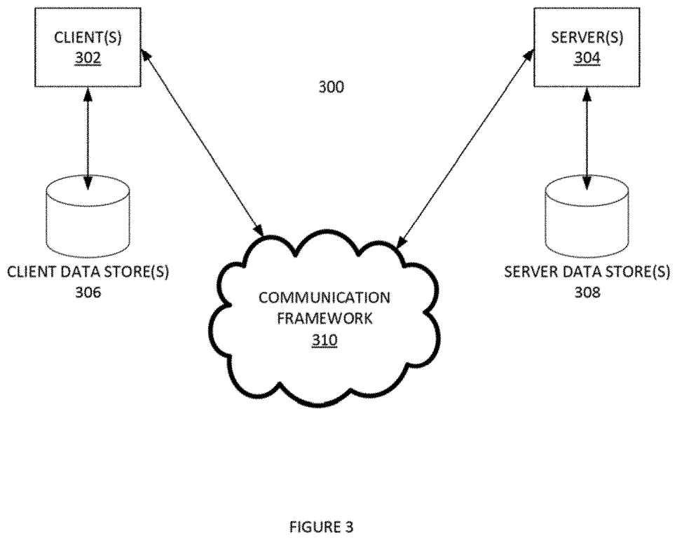

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

Exemplary Methods

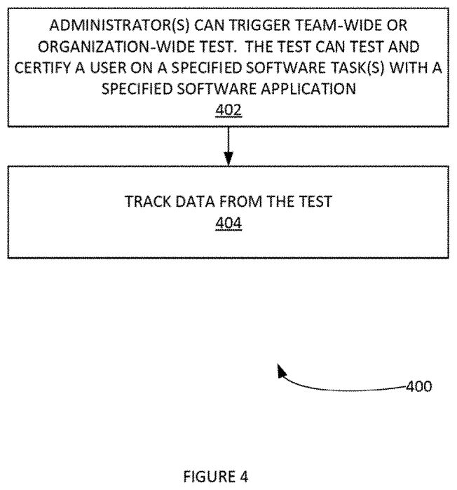

FIG. 4 provides an example process 400 for showing, testing and certifying users in-app on cloud application workflows, according to some embodiments. In step 402, an administrator(s) can trigger team-wide or organization-wide test. The test can test and certify a user on a specified software task(s) with a specified software application. In step 404, process 400 can track data from the test(s). Example tracked data can include, inter alia: how much time is taken? (e.g. an efficiency score); how many steps are taken? (e.g. an effectiveness score); an update on a new team workflow (e.g. generate a new form to enter data); etc. The tracked data can be provided to administrator(s) for analysis. The tracked data can be used to improve training workflows. In some examples, machine-learning algorithms can be used to automatically suggest updates to the training workflows. In this case, the tracked data as training data.

Example Screen Shots

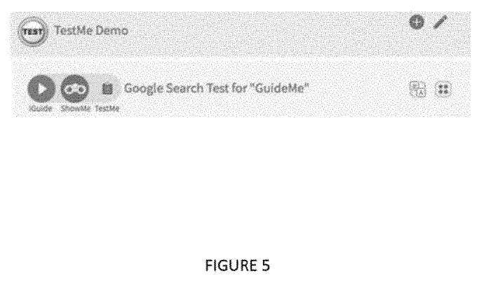

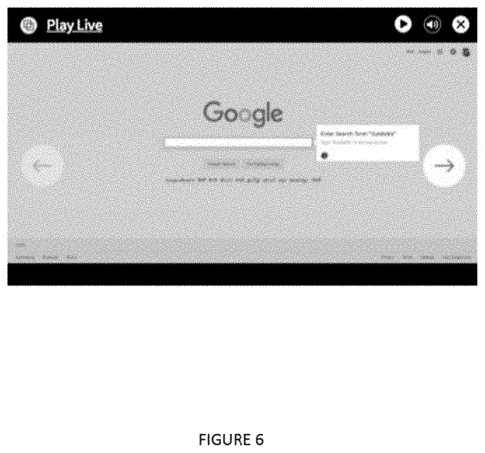

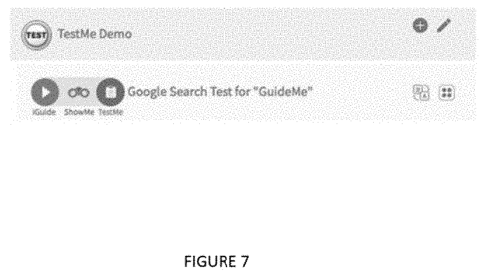

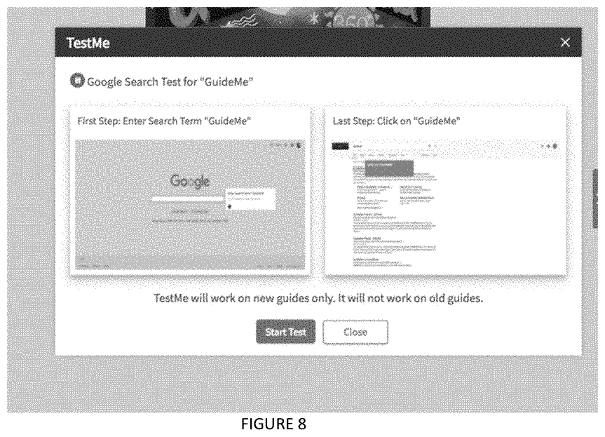

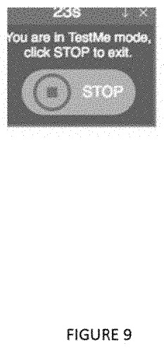

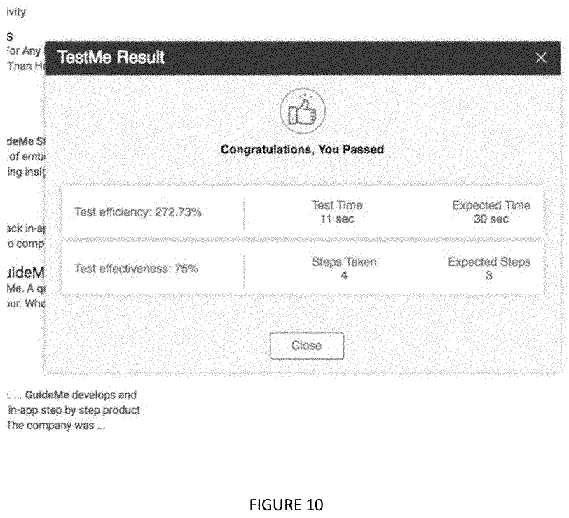

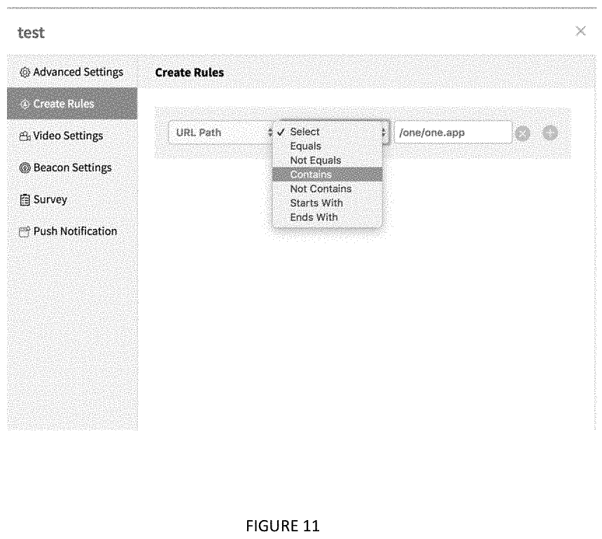

FIGS. 5-11 illustrate a series of example screen shots that can be used to implement various embodiments. More specifically, FIG. 5 illustrates an example screen shot of an interface for launching a ShowMe functionality. FIG. 6 illustrates an example educational slideshow of the ShowMe functionality. FIG. 7 illustrates an example launching interface for a TestMe functionality for a specific application workflow. FIG. 8 illustrates an example interface showing an initial step and goal step. FIG. 9 illustrates an interface with a running of a test with timer. FIG. 10 illustrates an interface showing completion of a test along with efficiency and effectiveness scores. FIG. 11 illustrates an interface showing a rules engine for a workflow.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method useful for showing, testing and certifying users in-application on cloud application workflows comprising:
triggering a test, wherein the test tests and certifies a user on a specified software task with a specified software application;
tracking a set of user test data from the test; and
using the set of user test data that is tracked to improve in application training workflows.

2. The computerized method of claim 1, wherein the test comprises a team-wide test triggered by an administrator.

3. The computerized method of claim 1, wherein the test comprises an organization-wide test triggered by the administrator.

4. The computerize method of claim 1, wherein the set of user test data that is tracked comprises a length of time to take the test.

5. The computerize method of claim 4, wherein the set of user test data that is tracked comprises a how many steps are taken by the user to complete the test.
